(19) United States
(12) Patent Application Publication
(10) Pub. No.: US 2004/0103651 A1
(43) Pub. Date: Jun. 3, 2004

(54) Desulfating a nox-trap in a diesel exhaust system

(76) Inventors: Christopher John Bennett, Exton, PA (US); David Scott Lafyatis, Malvern, PA (US)

Correspondence Address: RATNERPRESTIA, P O BOX 980, VALLEY FORGE, PA, 19482-0980, US

(21) Appl. No.: 10/250,835

(22) PCT Filed: Dec. 14, 2001
(86) PCT No.: PCT/GB01/05503

(30) Foreign Application Priority Data
Jan. 3, 2001 (GB) 0100067.8

(51) Int. Cl. B01J 38/02; F01N 3/10

(52) U.S. Cl. 60/286; 502/56

(57) ABSTRACT

A method of removing sulfur from a NOx-trap composition positioned downstream and/or on an electric heater in a diesel exhaust system comprises the step of periodically heating the electric heater when the exhaust gas composition is lean, thereby to desorb SOx adsorbed on the NOx trap composition. An exhaust system for carrying out the method comprises an electric heater, a NOx-trap composition positioned downstream and/or on the electric heater and means for controlling the electric heater to periodically heat the NOx-trap composition when the exhaust gas composition is lean, thereby to desorb SOx adsorbed on the NOx-trap composition.

The present invention relates to an exhaust system for a diesel engine, and in particular to an exhaust system including a regenerable absorber/catalyst or (lean) NOx trap (LNT) composition for treating nitrogen oxides (NOx) as one of its elements.

Manufacturers are increasingly interested in engines which operate under lean-running conditions to power their vehicles. One reason for this is because lean-burn engines produce less CO₂. This is advantageous because future emission legislation aims to reduce CO₂, but the consumer also benefits from the increased fuel economy. Using engine management techniques and/or employing one or more catalytic converter in a vehicle's exhaust system can control the gaseous composition of the exhaust so that the vehicle meets the relevant emission legislation.

One form of lean-burn engine is a gasoline direct injection engine, which is designed to operate under stoichiometric and lean conditions. When running lean, relatively low levels of NOx are formed that cannot be reduced (removed) in the presence of the relatively high levels of oxygen in the exhaust gas. Reducing species, e.g. unburnt hydrocarbons, can reduce NOx to N₂ during stoichiometric- or rich-running conditions, as comparatively less oxygen is present than during lean-running conditions. In order to control NOx in lean-burn engines, there has been devised a NOx absorber/catalyst which can store NOx, e.g. as nitrate, when an engine is running lean. In a stoichiometric or rich environment, the nitrate is understood to be thermodynamically unstable, and the stored NOx is released and is reduced by the reducing species present in the exhaust gas. This NOx absorber/catalyst is commonly called a NOx-trap or lean NOx-trap (LNT). By periodically controlling the engine to run stoichiometrcally or rich, stored NOx is reduced and the NOx-trap regenerated.

A typical NOx-trap formulation includes a component catalytic for oxidation, such as platinum, a NOx-storage component, such as barium, and a reduction catalyst e.g. rhodium. One mechanism commonly given for NOx-storage during lean engine operation for this formulation is: (i) NO+½O₂→NO₂; and (ii) BaO+NO₂½O₂→Ba(NO₃)₂. In the first step, the nitric oxide reacts with oxygen on active oxidation sites on the platinum to form NO₂. The second step involves adsorption of the NO₂ by the storage material in the form of an inorganic nitrate.

When the engine runs under rich conditions and/or at elevated temperatures, the nitrate species become thermodynamically unstable and decompose, producing NO or NO₂ according to equation (iii) below. Under rich conditions, these nitrogen oxides are subsequently reduced by carbon monoxide, hydrogen and hydrocarbons to N₂, which can take place over the reduction catalyst. (iii) Ba(NO₃)₂→BaO+2NO+3/2O₂ or Ba(NO₃)₂→BaO+2NO₂+½O₂; and (iv) NO+CO→½N₂+CO₂ (and other reactions). In the reactions of (i)-(iv) above the reactive barium species is given as the oxide. However, it is understood that in the presence of air, the barium can be present in the form of the carbonate or possibly the hydroxide. The above reaction schemes can be adapted accordingly for species of barium other than the oxide.

A significant problem in employing NOx-traps is that sulfur oxides (SOx) compounds in the exhaust gas derived from the fuel and/or engine lubricant are also oxidised by the oxidation catalyst components in the NOx-trap composition. These oxidised SOx compounds can be stored on the base metal NOx-storage components of a NOx-trap as the sulfate. Generally, the sulfate base metal compounds tend to be more thermally stable than the nitrates (decomposing at up to 200° C. higher) under both lean and rich exhaust gas conditions, so that when the rich regeneration step for the NOx-trap composition is performed, the sulfate compounds tend to remain. As this cycle is repeated, more and more of the available storage sites on the NOx-storage components become clogged with sulfates and the NOx-trap composition and the NOx storage efficiency of the composition is reduced.

A prior art strategy adopted to remove stored sulfates from the NOx-trap is to occasionally run the engine rich for an extended period at temperatures above normal lean/rich cycling hereby to regenerate the NOx-trap.

Recently, there has been increased interest in adopting NOx storage strategies for use with diesel engines. However, diesel engines present a number of problems in this regard: the exhaust gas temperatures are generally cooler in diesel engines in e.g. GDI or ther lean-burn engines; and diesel engines are difficult to run under rich conditions for extended periods without affecting driveability as a result of the nature of the combustion of the fuel, i.e. compression ignition instead of spark ignition in gasoline engines. Thus while lean/rich cycling to provide for NOx-trap regeneration is achievable, the combination of lower exhaust gas temperatures and the problems in running under rich conditions make the above described strategy for removing sulfate from a NOx-traps particularly difficult.

In practice new storage materials which store NOx at lower temperatures are being used, and sophisticated engine control strategies have been proposed to permit a decrease in air to fuel ratio in order to regenerate the NOx trap composition.

One prior art method of desulfating a NOx-trap is a diesel exhaust system under rich conditions is described in EP-A-758713. The exhaust system comprises an oxidation catalyst including an electric heater, a downstream diesel particulate filter and a NOx-trap downstream of the filter. The system employs sophisticated and complicated control circuitry to control the regeneration of the NOx-trap and/or the filter. In particular, the engine air intake valve; the amount of fuel injection to one or more engine cylinders; and activation of the electric heater are controlled in response to input from an array of sensor providing information regarding engine speed, accelerator attitude and fill-status of the filter and NOx-trap. In an illustrated embodiment, a method of high temperature, rich regeneration of the NOx-trap to release stored NOx and SOx is described including the step of activating the electric heater.

EP 1057983A describes an exhaust gas purification system for a lean burn internal combustion engine, particularly an engine capable of operating in a stratified charge lean burn mode. The exhaust system comprises a close-coupled three-way catalyst, a hydrocarbon trap down of the three-way catalyst, a NOx trap downstream of the hydrocarbon tap, and an electrically heated catalyst located between the hydrocarbon trap and the NOx trap. The NOx trap can be integrated with a particulate filter to treat particulate emissions generated during stratified lean-burn operation due to incomplete fuel-air mixing. A method is described for using the electrically heated catalyst to desulfate the NOx trap by switching the engine air-fuel ratio to a rich set point.

We have now found a way in which an electric heater can be used to assist in removing sulfur from a NOx-trap composition in a diesel exhaust system under lean conditions. Electric heaters have been proposed for use in prior art systems for heating catalysts to light-off temperatures immediately following cold-start. However, a major drawback of this use is that it draws a large amount of current away from the battery at start-up and this can result in insufficient power for performing other functions at start-up and reduced battery life. The present invention uses an electric heater for removing sulfur from a NOx-trap composition after the engine has warmed up.

According to one aspect, the invention provides an internal combustion engine comprising an exhaust system, which system comprising an electric heater and a NOx-trap composition, which NOx-trap composition is downstream and/or on the electric heater, characterised in that the engine is a diesel engine and in that the system further comprises means in use, for desorbing SOx adsorbed on the NOx-trap composition by controlling the electric heater to periodically heat the NOx-trap composition when the exhaust gas composition is lean.

Where the NOx-trap composition or a catalyst is on an electric heater, this arrangement can be referred to as an electrically heated catalyst (EHC).

The NOx-trap composition can be any composition suitable for the purpose, but very generally will comprise three elements: an oxidation catalyst such as platinum or palladium, or a base metal catalyst such as manganese; a NOx-storage component such as an oxide, hydroxide or carbonate of an alkali metal e.g. potassium or caesium, an alkaline earth such as barium, calcium or strontium or a rare earth such as cerium or yttrium; and a reduction catalyst e.g. rhodium.

By “periodically” herein, we mean, when the control means predicts or senses that the capacity of the NOx-trap composition has been reduced below a pre-set amount. This can be at least once every time the engine is switched on or following an extended period of use e.g. after 8000 km of driving. However, in one embodiment the period is from a few minutes, e.g. 2 minutes, to an hour or so. This “little-and-often” strategy is advantageous in that we have found that sulfated washcoat supports, such as alumina, are more difficult to desulfate. Sulfation of washcoat components over NOx storage components can occur after extended exposure to sulfur. The “little-and-often” strategy is designed to avert more serious washcoat component sulfation.

In one embodiment, the electric heater further comprises a hydrocarbon (HC) trap material coated thereon. This can be in addition to a NOx-trap composition on the electric heater. The HC-trap material can be any suitable for the purpose, and can include zeolites, other molecular sieves, crystalline silicates, crystalline silicate-containing species, aluminas, silicas, (optionally amorphous) aluminosilicates, layered clays and aluminium phosphates. Where the trap material is zeolite, it can be beta-zeolite or elite Y or ZSM-5, all optionally metal-substituted.

In this embodiment, the control means also can control the electric heater to heat the HC-trap material to a temperature and for a period sufficient to desorb HC adsorbed thereon.

The nature of the diesel engine is not important and the invention can be applied to all forms of diesel engine, including light-duty- and heavy-duty-diesel engines as defined by the relevant European, U.S. Federal or Californian legislation. For example, the engine can utilise modern fuel-injection techniques, such as common rail injection.

In one embodiment the control means controls the electric heater to heat the NOx-trap composition to a temperature and for a period sufficient to remove sulfur stored thereon. Thus, the invention can be used in combination with a diesel engine operated without lean/rich cycling, as in normal lean-running diesel engines, or in the modern diesel engines employing periodic rich running engine conditions for NOx-trap composition regeneration.

The means for controlling the exhaust system preferably includes a pre-programmed microchip. The microchip can include stored maps to predict cumulative NOx and SOx emitted by the engine depending on engine load and speed thereby to control the regeneration process at specific points in the driving cycle. Alternatively, or in addition, the control means can include on-board diagnostics for e.g. sensing temperature, NOx-trap fill status for both NOx and SOx and exhaust gas composition, and controlling the regeneration process accordingly.

Of course, in the system according to the invention, the electric heater can be used to increase the temperature of the NOx-trap composition during periods when it is below the temperature for optimal NOx-storage and/or NOx reduction. Such periods can occur when the exhaust gas temperature is relatively low because the load on the engine is low and/or the engine is performing little or no acceleration. The electric heater can improve the activity of the NOx-trap composition, with advantage, if it is about 30° C. or above the temperature of the exhaust gas.

According to a further aspect, there is provided a vehicle including a diesel engine according to the present invention.

In a further aspect, the invention provides a method of removing sulfur from a NOx-trap composition in a diesel exhaust system, which NOx-trap composition is positioned dowstream and/or on an electric heater, which method comprises the step of periodically heating the electric heater when the exhaust gas composition is lean, thereby to desorb SOx adsorbed on the NOx trap composition.

Presently, we envisage the following specific strategies for using an electric heater to remove sulfur from a NOx-trap composition disposed in a diesel exhaust system, using engine management techniques in addition where appropriate.

It is known that, in general, if the temperature is high enough sulfur can be removed from a base metal NOx storage component such as barium, potassium or curium, under lean-running conditions, i.e. where the exhaust gas is at λ>1. Accordingly, in a first embodiment, an electric heater is disposed either in front of a NOx-trap composition, or the NOx-trap composition is coated on the electric heater. Of course, the NOx-trap composition can be arranged so that it is both on and downs of the electric heater. Where the electric heater is positioned upstream of the NOx-trap composition, the electric heater is used to heat exhaust gas flowing thereover to a sufficient temperature to heat the downstream NOx-trap composition and for a sufficient time thereby to decompose the sulfate and remove the sulfur from the composition. In the alternative, where the NOx-trap composition is on the electric heater, the NOx-trap composition is heated directly to achieve the required temperature.

This technique has the advantage that the sulfur is removed from the NOx-trap as SO₂ and is passed to atmosphere. Prior art methods employing rich conditions to remove SOx lead to the sulfur being released as H₂S, which is not a regulated pollutant, but does cause an undesirable odour. A further advantage is that there is no significant fuel penalty in performing the regeneration process.

In a second embodiment, sulfur removal is performed under normal lean-running conditions and the exhaust system includes a HC-trap material. The HC-trap material, such as a zeolite, is coated on the electric heater and the NOx-trap composition is disposed on and/or downstream of the electric heater. Under the relatively cool normal lean conditions of the diesel engine, unburnt HCs, particularly heavy HCs typically found in diesel exhaust e.g. decane can adsorb to the HC trap material. The strategy for removing sulfur from the NOx-trap composition includes heating the electric heater thereby to desorb the HC from the HC trap material thereon HC (either desorbed HC or HC directly from the engine) is combusted over the NOx-trap oxidation catalyst thereby generating an exotherm over the NOx-trap composition is exotherm can be used to increase the temperature of the NOx-trap composition sufficiently to remove sulfur in normal, lean-running engine conditions.

An advantage of this embodiment is that normal, lean operating engine conditions are maintained, so there is no fuel penalty. Also the sulfur is driven off as SO₂ which is odourless, whereas methods employing rich regeneration produce unpleasant smelling H₂S. Furthermore, because the method utilises an exotherm derived from the combustion of HC over the NOx-trap composition to heat the composition to a temperature at which sulfur can be removed, less power is required to heat the electric heater.

A third embodiment is a modification of the second embodiment in which the air-to-fuel ratio of the engine is adjusted so that it is just stoichiometric, e.g. 15:1. HCs desorbed from the HC-trap are sufficient to make the exhaust gas rich over the NOx-trap composition. Advantages of this embodiment are that NOx, as well as SOx, can be removed from the NOx-trap composition during the local enrichment event; since the exhaust composition is locally (i.e. over the NOx-trap composition) rich, and sulfur removal is possible as lower temperatures, less power is required to heat the electric heater, less power is required to heat the electric heater because the exotherm produced from combusting the HC is used to heat the NOx-trap composition; and lean condition are maintained so there is a fuel-saving over adjusting the airs fuel ratio to the rich side.

Accordingly in one embodiment, the electric heater fiber comprises a hydrocarbon (HC) trap material on the electric heater for adsorbing HC, and the method comprises the step of heating the electric heater to desorb HC adsorbed on the trap material and the HC is combusted over the NOx-trap composition thereby to heat, or to heat in part, the NOx-trap composition to remove sulfur therefrom.

In a variation of this embodiment, the air-fuel ratio of the engine is decreased to sightly lean of stoichiometric conditions.

According to a further aspect, the invention provides the use of an electric heat to remove sulfur stored on a NOx-trap composition in a diesel exhaust system.

1. An internal combustion engine comprising an exhaust system, which system comprising an electric heater and a NOx-trap composition, which NOx-trap composition is downstream and/or on the electric heater, characterised in that the engine is a diesel engine and in that the system further comprises means, in use, for desorbing SOx adsorbed on the NOx-trap composition by controlling the electric heater to periodically heat the NOx-trap composition when the exhaust gas composition is lean.

2. An engine according to claim 1, further comprising a hydrocarbon (HC) trap material on the electric heater.

3. An engine according to claim 2, wherein the control means controls the electric heater to heat the HC-trap material to a temperature and for a period sufficient to desorb HC adsorbed thereon.

4. An engine according to claim 3, wherein the control means controls the air-to-fuel ratio to slightly lean of stoichiometric conditions.

5. An eye according to claim 1, wherein the control means controls the electric heater to heat the NOx-trap composition to a temperature and for a period sufficient to remove SOx thereon.

6. An engine according to any preceding claim, wherein the control means includes a pre-programmed microchip.

7. A vehicle including a diesel engine according to any preceding claim.

8. A method of removing sulfur from a NOx-trap composition in a diesel exhaust system, which NOx-trap composition is positioned downstream and/or on an electric heater, which method comprises the step of periodically heating the electric heater when the exhaust gas composition is lean, thereby to desorb SOx adsorbed on the NOx-trap composition.

9. A method according to claim 8, wherein the electric heater further comprises a hydrocarbon (HC) trap material on the electric heater for adsorbing HC, whereby heating the electric heater desorbs HC adsorbed on the trap material and the HC is combusted over the NOx-trap composition thereby to heat, or to heat in part, the NOx-trap composition to remove sulfur therefrom.

10. A method according to claim 9, wherein the air-to-fuel ratio is decreased to slightly low of stoichiometric conditions.
